(19) United States
(12) Patent Application Publication
(10) Pub. No.: US 2024/0412919 A1
(43) Pub. Date: Dec. 12, 2024

(54) COIL COMPONENT

(71) Applicant: Murata Manufacturing Co., Ltd., Kyoto-fu (JP)

(72) Inventor: Kota TAKAYAMA, Nagaokakyo-shi (JP)

(73) Assignee: Murata Manufacturing Co., Ltd., Kyoto-fu (JP)

(21) Appl. No.: 18/676,971

(22) Filed: May 29, 2024

(30) Foreign Application Priority Data
Jun. 7, 2023 (JP) 2023-093584

(51) Int. Cl. H01F 27/30; H01F 27/24; H01F 27/28; H01F 27/29

(52) U.S. Cl. CPC H01F 27/306; H01F 27/24; H01F 27/2823; H01F 27/292

(57) ABSTRACT

A groove for receiving an end portion of a wire is on a mounting surface of a flange. The groove extends in a direction in which an inner end surface and an outer end surface of the flange are linked with each other. The groove has a bottom surface sandwiched between first and second sides extending in the direction in which the inner end surface and the outer end surface are linked with each other. The first side is located closer to an extending position of the wire from a winding core than is the second side. The distance between the first side and the second side on the inner end surface is narrower and that on the outer end surface is wider. The angle of the first side with respect to an axial direction is smaller than that of the second side with respect to the axial direction.

### CROSS-REFERENCE TO RELATED APPLICATION

This application claims benefit of priority to Japanese Patent Application No. 2023-093584, filed Jun. 7, 2023, the entire content of which is incorporated herein by reference.

### BACKGROUND

### Technical Field

The present disclosure relates to a winding-type coil component, and more particularly, to a structure of a portion of a flange, which is provided for a core unit of the coil component, to be connected to a wire.

### Background Art

An example of this type of coil component is disclosed in Japanese Unexamined Patent Application Publication No. 2006-100748. This coil component includes a core unit, first and second terminal electrodes, and a wire. The core unit includes a winding core and first and second flanges. The first flange is provided at a first end portion of the winding core, while the second flange is provided at a second end portion of the winding core. The first and second end portions of the winding core are positioned on the opposite sides in the axial direction. The first terminal electrode is provided on the first flange, while the second terminal electrode is provided on second flange. The wire is wound around the winding core and is connected between the first and second terminal electrodes.

Each of the first and second flanges has a quadrilateral shape having four peripheral surfaces in cross section. A groove is formed on the four peripheral surfaces. The groove has a bottom surface and two rising surfaces. The bottom surface is sandwiched between two sides which are parallel with the axial direction of the winding core. The two rising surfaces rise from the bottom surface via the two respective sides. Each of the above-described terminal electrodes is provided on one or more of the peripheral surfaces of the flange. The end portions of the wire are stored in the grooves and are connected to the terminal electrodes.

### SUMMARY

In the above-described groove, the two sides that define the bottom surface and the two rising surfaces extend in parallel with the axial direction of the winding core. Because of this configuration, the angle of the wire to extend from the winding core to the groove and to be connected to the terminal electrode tends to be restricted, and the flexibility in inserting the wire into the groove is relatively low. For example, the wire is typically inserted into the groove obliquely, and while the wire is being inserted, the forward end of the wire may touch the rising surface which is farther away from the position at which the wire separates and extends from the winding core than the other rising surface. This may hinder the movement of the wire inserted into the groove.

Additionally, since the two sides that define the bottom surface of the groove and the two rising surfaces extend in parallel with the axial direction of the winding core, the width of the groove that can receive the wire tends to become wide. This increases variations in the position of the wire within the groove.

Accordingly, the present disclosure provides a coil component having a structure which is able to increase the flexibility in inserting a wire into a groove formed in a flange of a core unit and also to reduce variations in the position of the wire within the groove.

A coil component according to an aspect of the disclosure includes a core unit. The core unit includes a winding core extending in an axial direction and first and second flanges. The first flange is provided at a first end portion of the winding core, while the second flange is provided at a second end portion of the winding core. The first and second end portions are positioned on opposite sides in the axial direction.

Each of the first and second flanges has a mounting surface, an inner end surface, and an outer end surface. The mounting surface faces a mounting substrate at a time of mounting of the coil component on the mounting substrate. The inner end surface faces the winding core. The outer end surface is positioned at an opposite side of the inner end surface.

The coil component also includes first and second terminal electrodes and at least one wire. The first terminal electrode is provided at least on the mounting surface of the first flange. The second terminal electrode is provided at least on the mounting surface of the second flange. The at least one wire is wound around the winding core and is connected between the first and second terminal electrodes.

A groove is provided on the mounting surface of at least one of the first and second flanges. The groove is used for receiving an end portion of the at least one wire and extends in a direction in which the inner end surface and the outer end surface are linked with each other. The groove is opened at least on a side of the inner end surface and has a bottom surface and first and second rising surfaces. The bottom surface is sandwiched between first and second sides extending in the direction in which the inner end surface and the outer end surface are linked with each other. The first rising surface rises from the bottom surface via the first side, while the second rising surface rises from the bottom surface via the second side. The first side is located closer to an extending position of the at least one wire than the second side is. The extending position is a position at which the at least one wire separates and extends from the winding core.

To address the above-described issues, in the coil component configured as described above, the distance between the first side and the second side on the side of the inner end surface is narrower and the distance between the first side and the second side on the side of the outer end surface is wider. The angle of the first side with respect to the axial direction is smaller than the angle of the second side with respect to the axial direction.

According to an embodiment of the disclosure, regarding the distance between the first side and the second side, which define the shape of the bottom surface of a groove for receiving an end portion of a wire, the distance on the side of the inner end surface is narrower, while the distance on the side of the outer end surface is wider. Additionally, the angle of the first side with respect to the axial direction is smaller than the angle of the second side with respect to the axial direction. With this configuration, the inserting of the wire into the groove is less hindered, and variations in the position of the wire within the groove can also be reduced.

### BRIEF DESCRIPTION OF THE DRAWINGS

FIG. 1 is a front view illustrating the exterior of a coil component according to a first embodiment of the disclosure;

FIG. 2 is a bottom view of the coil component when mounting surfaces of the coil component are seen from above;

FIG. 3 is an enlarged perspective view of a portion of a core unit included in the coil component shown in FIG. 2 when the mounting surface is seen obliquely;

FIG. 4 is an enlarged bottom view of the portion of the core unit shown in FIG. 3 when the mounting surface is seen from above;

FIG. 5 is a view corresponding to FIG. 4 and illustrates a portion of a core unit included in a coil component according to a second embodiment of the disclosure;

FIG. 6 is a view corresponding to FIG. 4 and illustrates a portion of a core unit included in a coil component according to a third embodiment of the disclosure;

FIG. 7 is a view corresponding to FIG. 4 and illustrates a portion of a core unit included in a coil component according to a fourth embodiment of the disclosure; and

FIG. 8 is a view corresponding to FIG. 4 and illustrates a portion of a core unit included in a coil component according to a fifth embodiment of the disclosure.

### DETAILED DESCRIPTION

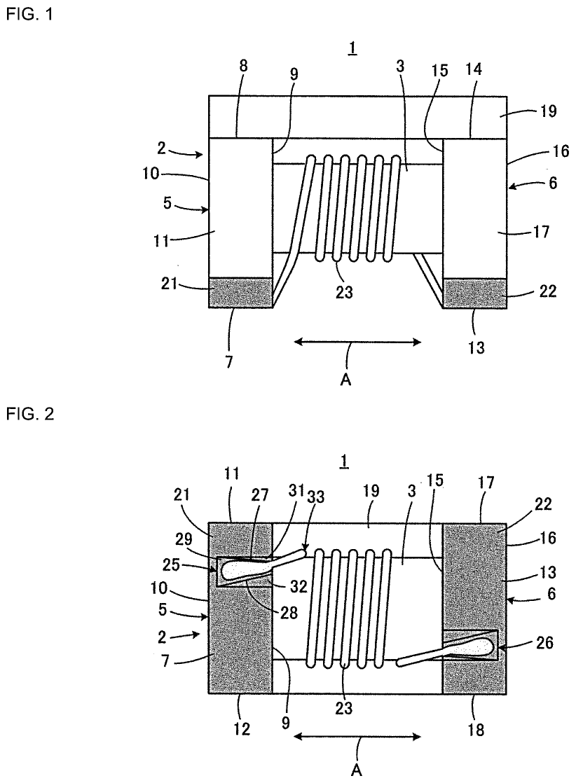

A coil component 1 according to a first embodiment of the disclosure will be described below with reference to FIGS. 1 through 4.

As illustrated in FIGS. 1 and 2, the coil component 1 includes a core unit 2. The core unit 2 is typically made of ferrite, but may alternatively be made of a resin containing ferrite powder, alumina powder, or magnetic metal powder, for example. The core unit 2 includes a winding core 3 extending in the axial direction A and first and second flanges 5 and 6. The first flange 5 is provided at a first end portion of the winding core 3, while the second flange 6 is provided at a second end portion of the winding core 3. The first and second end portions are positioned on the opposite sides in the axial direction A.

The cross sectional shape of the winding core 3 perpendicular to the axial direction A is a quadrilateral. The ridge portions of the winding core 3 having a quadrilateral shape may be chamfered. The cross sectional shape of the winding core 3 may alternatively be a polygon, such as a hexagon, a circle, an ellipse, or a shape having a suitable combination of these shapes.

The shapes of the first and second flanges 5 and 6 are a quadrilateral prism and are symmetrical to each other.

The first flange 5 has a mounting surface 7, a top surface 8, an inner end surface 9, an outer end surface 10, and first and second side surfaces 11 and 12. The mounting surface 7 faces a mounting substrate at the time of the mounting of the coil component 1 on the mounting substrate. The top surface 8 is positioned at the opposite side of the mounting surface 7. The inner end surface 9 links the mounting surface 7 and the top surface 8 with each other and faces the winding core 3. The outer end surface 10 is positioned at the opposite side of the inner end surface 9. The first and second side surfaces 11 and 12 face each other and links the mounting surface 7 and the top surface 8 with each other and the inner and outer end surfaces 9 and 10 with each other.

Likewise, the second flange 6 has a mounting surface 13, a top surface 14, an inner end surface 15, an outer end surface 16, and first and second side surfaces 17 and 18. The mounting surface 13 faces a mounting substrate at the time of the mounting of the coil component 1 on the mounting substrate. The top surface 14 is positioned at the opposite side of the mounting surface 13. The inner end surface 15 links the mounting surface 13 and the top surface 14 with each other and faces the winding core 3. The outer end surface 16 is positioned at the opposite side of the inner end surface 15. The first and second side surfaces 17 and 18 face each other and links the mounting surface 13 and the top surface 14 with each other and the inner and outer end surfaces 15 and 16 with each other.

The ridge portions of the first and second flanges 5 and 6 may be chamfered. The first and second flanges 5 and 6 may be formed in a shape other than a quadrilateral prism if the first flange 5 has the mounting surface 7, the inner end surface 9, and the outer end surface 10 and if the second flange 6 has the mounting surface 13, the inner end surface 15, and the outer end surface 16.

The coil component 1 may include a top plate 19. The top plate 19 is disposed between the top surface 8 of the first flange 5 and the top surface 14 of the second flange 6. The top plate 19 is fixed to the core unit 2 by a thermosetting resin, such as an epoxy-based adhesive agent, though such a state is not shown. The dimension of the top plate 19 in the axial direction A and that in a direction perpendicular to the plane of the drawing of FIG. 1 are desirably larger than or equal to the corresponding dimensions of the core unit 2. The top plate 19 is made of ferrite or a resin containing ferrite powder, alumina powder, or magnetic metal powder, for example. Instead of the top plate 19, the top surface of the core unit 2 may be coated with a resin, such as an ultra-violet (UV) curable resin.

The coil component 1 includes first and second terminal electrodes 21 and 22. The first terminal electrode 21 is provided at least on the mounting surface 7 of the first flange 5. The second terminal electrode 22 is provided at least on the mounting surface 13 of the second flange 6. The regions where the first and second terminal electrodes 21 and 22 are formed are filled in a dark color in FIGS. 1 through 4 so that they can be distinguished from the other regions. It is thus seen that the terminal electrode 21 is formed on the mounting surface 7 and also extends to other surfaces adjacent to the mounting surface 7, that is, part of each of the inner end surface 9, the outer end surface 10, and the first and second side surfaces 11 and 12. Likewise, the terminal electrode 22 is formed on the mounting surface 13 and also extends to other surfaces adjacent to the mounting surface 13, that is, part of each of the inner end surface 15, the outer end surface 16, and the first and second side surfaces 17 and 18.

The terminal electrodes 21 and 22 are formed as follows, for example. A conductive paste containing silver as a conductive component is applied to the first and second flanges 5 and 6 and is burned, and is then plated with copper, nickel, and tin in this order. The thickness of the silver layer is 5 to 30 μm, for example. The thickness of the copper layer is 1 to 5 μm, for example. The thickness of the nickel layer is 1 to 5 μm, for example. The thickness of the tin layer is 5 to 20 μm, for example.

The coil component 1 also includes at least one wire 23 which is wound around the winding core 3 and which is connected between the first and second terminal electrodes 21 and 22. The wire 23 has a center rod made of a high-conductivity metal, such as copper, silver, or gold, and the center rod is coated with a resin, such as polyurethane or polyamide-imide. The diameter of the center rod of the wire 23 is set to 60 to 180 μm, for example, though it is not limited to a particular size. The number of turns of the wire 23 around the winding core 3 can be changed as desired in accordance with the required characteristics.

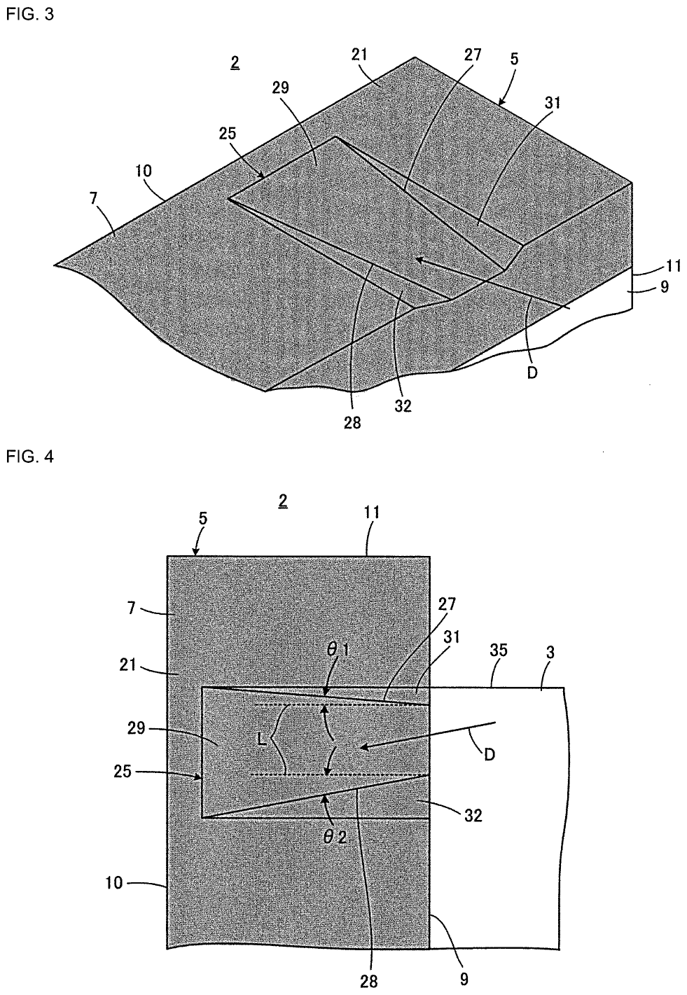

The wire 23 may be connected to the terminal electrodes 21 and 22 by thermal pressure-bonding, for example. Grooves 25 and 26 for receiving the end portions of the wire 23 are provided on the mounting surfaces 7 and 13, respectively. The groove 25 extends in a direction in which the inner end surface 9 and the outer end surface 10 are linked, and the groove 26 extends in a direction in which the inner end surface 15 and the outer end surface 16 are linked. As shown in FIG. 2, the first flange 5 provided with the groove 25 and the second flange 6 provided with the groove 26 are substantially point-symmetrical to each other. An explanation will thus be given only of the detailed configuration of the groove 25 shown in FIGS. 3 and 4, and an explanation of the detailed configuration of the groove 26 will be omitted.

Regarding the groove 25 provided on the mounting surface 7 of the first flange 5, the side of the groove 25 on the inner end surface 9 is opened, as is typically seen in FIGS. 3 and 4. The groove 25 has a bottom surface 29 and first and second rising surfaces 31 and 32. The bottom surface 29 is sandwiched between a first side 27 and a second side 28 extending in a direction in which the inner and outer end surfaces 9 and 10 are linked with each other. The first rising surface 31 rises from the bottom surface 29 via the first side 27, while the second rising surface 32 rises from the bottom surface 29 via the second side 28. The first side 27 is located closer to an extending position 33 (see FIG. 2) of the wire 23 than the second side 28 is. The extending position 33 is a position at which the wire 23 separates and extends from the winding core 3. The extending direction of the wire 23 is indicated by the arrow D in FIGS. 3 and 4.

When the groove 25 is viewed from the bottom surface 29, it is seen that the distance between the first side 27 and the second side 28 on the side of the inner end surface 9 is narrower and the distance therebetween on the side of the outer end surface 10 is wider. Additionally, as shown in FIG. 4, the angle θ1 of the first side 27 with respect to the axial direction A is smaller than the angle θ2 of the second side 28 with respect to the axial direction A. For the sake of representation, in FIG. 4, a line parallel with the axial direction A is indicated by the dotted line L.

As discussed above, regarding the distance between the first side 27 and the second side 28, which define the shape of the bottom surface 29 of the groove 25 for receiving an end portion of the wire 23, the distance on the side of the inner end surface 9 is narrower, while that on the side of the outer end surface 10 is wider. Additionally, the angle θ1 of the first side 27 with respect to the axial direction A (dotted line L) is smaller than the angle θ2 of the second side 28 with respect to the axial direction A (dotted line L). With this configuration of the groove 25, the inserting of the wire 23 into the groove 25 is less hindered. The wire 23 can thus be laid with high flexibility in accordance with the state of the wire 23 and the movement of a nozzle for feeding the wire 23. It is also possible to reduce variations in the position of the wire 23 within the groove 25.

When the wire 23 is thermally pressure-bonded to the first terminal electrode 21, a swollen portion of the wire 23 having a width of 200 μm and a height of 15 μm, for example, is formed on the bottom surface 29 of the groove 25.

As is seen from FIG. 3, preferably, the bottom surface 29 of the groove 25 slopes so that the groove 25 becomes shallower in a direction from the inner end surface 9 to the outer end surface 10. With this configuration, the wire 23 is less likely to be damaged while being pressure-bonded to the first terminal electrode 21, thereby reducing the occurrence of a breakage of the wire 23. Additionally, the end portion of the wire 23 does not suddenly become thin.

As is also seen from FIG. 3, preferably, the interior angle of each of the first rising surface 31 and the second rising surface 32 with respect to the bottom surface 29 of the groove 25 is an obtuse angle. This configuration makes it possible to smoothly insert the wire 23 into the groove 25.

It is now assumed that, concerning the first flange 5, a direction, which is the extending direction of the mounting surface 7 and is perpendicular to the axial direction A, is the widthwise direction. In this case, preferably, as illustrated in FIG. 2, the groove 25 is located toward the widthwise direction so as to be close to the extending position 33 of the wire 23. As a result, the groove 25 provided in the first flange 5 and the groove 26 provided in the second flange 6 are located on the opposite sides with respect to the widthwise direction, as shown in FIG. 2.

The wire 23 does not touch anywhere from when it is separated from the winding core 3 until it reaches the flange 5. With this configuration, the distance from the position of the wire 23 wound up on the winding core 3 to that in the groove 25 can become relatively short. That is, the length of the routing of the wire 23 in the air can be decreased, thereby making it possible to reduce the occurrence of a breakage of the wire 23.

As is seen from FIG. 2, the distance between the first side 27 and the second side 28, which define the bottom surface 29 of the groove 25, is preferably wider than the diameter of the wire 23. That is, preferably, the width of the groove 25 on the side of the inner end surface 9 and that on the side of the outer end surface 10 are both wider than the diameter of the wire 23. This makes it possible to easily store the wire 23 in the widthwise dimension of the groove 25.

As can be assumed from FIGS. 2 through 4, the depth of the groove 25, which is represented by the level difference between the mounting surface 7 of the first flange 5 and the bottom surface 29 of the groove 25, is preferably smaller than the diameter of the wire 23, though such a state is not shown. With this configuration, the wire 23 in cross section partially extends to the outside of the groove 25 while being pressure-bonded, thereby facilitating the pressure-bonding operation.

The configuration of the groove 26 provided on the mounting surface 13 of the second flange 6 is similar to that of the groove 25, though a detailed explanation thereof is not given. However, the groove 25 may be provided only in the first flange 5, and the provision of the groove 26 in the second flange 6 may be omitted. Alternatively, while the groove 25 is provided in the first flange 5 and the groove 26 is provided in the second flange 6, the above-described distinctive configuration may be applied only to the groove 25.

The coil component 1 is manufactured as follows, for example.

To obtain the drum-shaped core unit 2, ferrite powder is press-formed in a die and the resulting body is fired and is then deburred by barrel-polishing. As a result, the ridge portions of the core unit 2 are chamfered and are slightly rounded. An underlying electrode is formed on each of the mounting surface 7 of the flange 5 and the mounting surface 13 of the flange 6 of the core unit 2, and a plating film is formed on the underlying electrode by using an electrolyte barrel. Then, the wire 23 is wound around the winding core 3 of the core unit 2 by using a nozzle. The end portions of the wire 23 are then thermally pressure-bonded to the terminal electrodes 21 and 22 by using a heater tip. Thermal pressure-bonding of the wire 23 is performed for one second at a temperature of 500° C., for example. After the wire 23 is pressure-bonded to the terminal electrodes 21 and 22, the temperature of the heater tip is lowered and when it reaches 300° C. or lower, the heater tip is removed. Then, a surplus of the wire 23 connected to the terminal electrodes 21 and 22 is cut with a cutter blade.

If the top plate 19 is provided, it is bonded to the core unit 2 with an adhesive. If, instead of the top plate 19, the core unit 2 is coated with a resin, a resin is applied to the core unit 2 and is cured.

The resulting coil component 1 has the following dimensions, for example: a dimension of 3.2 mm in the axial direction A, a width of 2.5 mm in a direction perpendicular to the plane of the drawing of FIG. 1, and a height of 2.5 mm in a direction perpendicular to the plane of the drawing of FIG. 2.

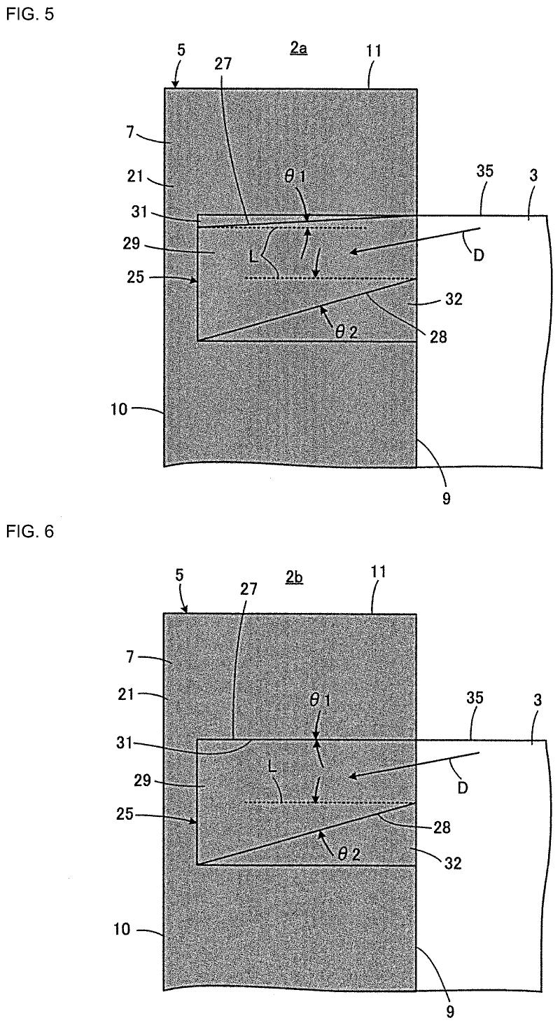

Other embodiments of the disclosure will be described below with reference to FIGS. 5 through 8. FIGS. 5 through 8 correspond to FIG. 4. Elements corresponding to those in FIG. 4 are designated by like reference numerals in FIGS. 5 through 8 and an explanation thereof will be omitted.

In second through fifth embodiments illustrated in FIGS. 5 through 8, as well as in the first embodiment, the first flange 5 shown in FIGS. 5 through 8 and the second flange 6, which is not shown, are substantially point-symmetrical to each other. An explanation will thus be given of the first flange 5, and an explanation of the second flange 6 will be omitted.

In the core unit 2 of the first embodiment shown in FIG. 4, the angle θ1 of the first side 27 with respect to the axial direction A (dotted line L) is an angle measured clockwise, while the angle θ2 of the second side 28 with respect to the axial direction A (dotted line L) is an angle measured counterclockwise.

In contrast, in a core unit 2a of the second embodiment illustrated in FIG. 5, the angle θ1 of the first side 27 and the angle θ2 of the second side 28 with respect to the axial direction A (dotted line L) are angles both measured counterclockwise. In the case of the second embodiment, too, the angle θ1 is smaller than the angle θ2.

In a core unit 2b of the third embodiment illustrated in FIG. 6, as is seen from the arrow D indicating the extending direction of a wire, the first side 27, which is located closer to the extending position of the wire from the winding core 3, extends in parallel with the axial direction A (dotted line L). If the groove 25 is located toward the widthwise direction so as to be close to the extending position of the wire 23 as discussed above, the configuration shown in FIG. 6 may be used advantageously. In the third embodiment, the interior angle between the first rising surface 31 and the bottom surface 29 may be set to a right angle.

In the third embodiment, the designing of a manufacturing die for the core unit 2b is facilitated, and accordingly, the core unit 2b may be manufactured easily.

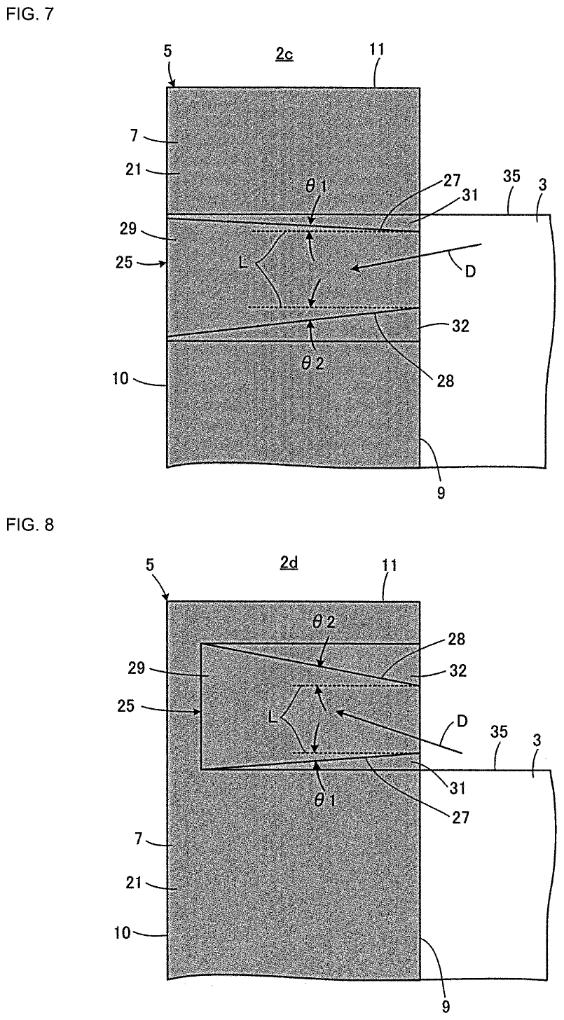

In a core unit 2c of the fourth embodiment illustrated in FIG. 7, the groove 25 is opened on the side of the outer end surface 10 as well as on the side of the inner end surface 9.

In the above-described first through fourth embodiments, the bottom surface 29 of the groove 25 is positioned farther inwards in the widthwise direction than a side surface 35 of the winding core 3. In contrast, in a core unit 2d of the fifth embodiment illustrated in FIG. 8, the bottom surface 29 of the groove 25 is positioned farther outwards in the widthwise direction than the side surface 35 of the winding core 3. Nevertheless, in the fifth embodiment, too, the angle θ1 of the first side 27, which is closer to the extending position of the wire from the winding core 3, with respect to the axial direction A (dotted line L) is smaller than the angle θ2 of the second side 28 with respect to the axial direction A (dotted line L), as is seen from the arrow D indicating the extending direction of the wire.

The disclosure has been described above through illustration of the embodiments with reference to the drawings. However, various modified examples may be made within the scope of the disclosure.

For example, in the above-described embodiments, a coil component forms a single coil. However, the coil component may form another type of coil, such as a common mode choke coil, or may form another electronic component, such as a transformer and a balun. The number of wires may thus be changed in accordance with the function of a coil component. The number of terminal electrodes and the number of grooves provided for each flange may be changed accordingly.

The shapes of the core unit and the top plate included in the coil component are not limited to those shown in the drawings and may be changeable as desired in accordance with the intended designing.

To form a coil component according to an embodiment of the disclosure, the configurations discussed in different embodiments in the specification may partially be replaced by or combined with each other.

Embodiments of the disclosure are as follows, for example.
<1> A coil component comprising a core unit including a winding core and first and second flanges, the winding core extending in an axial direction, the first flange being provided at a first end portion of the winding core, the second flange being provided at a second end portion of the winding core, the first and second end portions being positioned on opposite sides in the axial direction, each of the first and second flanges having a mounting surface, an inner end surface, and an outer end surface, the mounting surface facing a mounting substrate at a time of mounting of the coil component on the mounting substrate, and the inner end surface facing the winding core, the outer end surface being positioned at an opposite side of the inner end surface. The coil component further comprises first and second terminal electrodes, the first terminal electrode being provided at least on the mounting surface of the first flange, the second terminal electrode being provided at least on the mounting surface of the second flange; and at least one wire that is wound around the winding core and is connected between the first and second terminal electrodes. A groove is provided on the mounting surface of at least one of the first and second flanges, the groove being used for receiving an end portion of the at least one wire and extending in a direction in which the inner end surface and the outer end surface are linked with each other. The groove is opened at least on a side of the inner end surface and has a bottom surface and first and second rising surfaces, the bottom surface being sandwiched between first and second sides extending in the direction in which the inner end surface and the outer end surface are linked with each other, the first rising surface rising from the bottom surface via the first side, the second rising surface rising from the bottom surface via the second side. The first side is located closer to an extending position of the at least one wire than the second side is, the extending position being a position at which the at least one wire separates and extends from the winding core. A distance between the first side and the second side on the side of the inner end surface is narrower and a distance between the first side and the second side on a side of the outer end surface is wider, and an angle of the first side with respect to the axial direction is smaller than an angle of the second side with respect to the axial direction.
<2> The coil component according to <1>, wherein the groove is provided on the mounting surface of each of the first and second flanges.
<3> The coil component according to <1> or <2>, wherein the bottom surface of the groove slopes so that the groove becomes shallower in a direction from the inner end surface to the outer end surface.
<4> The coil component according to one of <1> to <3>, wherein an interior angle of each of the first and second rising surfaces with respect to the bottom surface is an obtuse angle.
<5> The coil component according to one of <1> to <4>, wherein, when a direction, which is an extending direction of the mounting surface and is perpendicular to the axial direction, is assumed to be a widthwise direction, the groove is located toward the widthwise direction so as to be close to the extending position of the at least one wire.
<6> The coil component according to <5>, wherein the first side extends in parallel with the axial direction.
<7> The coil component according to Claim one of <1> to <6>, wherein the distance between the first side and the second side is wider than a diameter of the at least one wire.
<8> The coil component according to one of <1> to <7>, wherein a depth of the groove, which is represented by a level difference between the mounting surface and the bottom surface, is smaller than a diameter of the wire.

What is claimed is:

1. A coil component comprising:
a core unit including a winding core and first and second flanges, the winding core extending in an axial direction, the first flange being at a first end portion of the winding core, the second flange being at a second end portion of the winding core, the first and second end portions being on opposite sides in the axial direction, each of the first and second flanges having a mounting surface, an inner end surface, and an outer end surface, the mounting surface facing a mounting substrate at a time of mounting of the coil component on the mounting substrate, the inner end surface facing the winding core, and the outer end surface being at an opposite side of the inner end surface;
first and second terminal electrodes, the first terminal electrode being at least on the mounting surface of the first flange, the second terminal electrode being at least on the mounting surface of the second flange; and
at least one wire that is wound around the winding core and is connected between the first and second terminal electrodes, wherein
a groove is on the mounting surface of at least one of the first and second flanges, the groove being configured to receive an end portion of the at least one wire and extending in a direction in which the inner end surface and the outer end surface are linked with each other,
the groove is opened at least on a side of the inner end surface and has a bottom surface and first and second rising surfaces, the bottom surface being sandwiched between first and second sides extending in the direction in which the inner end surface and the outer end surface are linked with each other, the first rising surface rising from the bottom surface via the first side, and the second rising surface rising from the bottom surface via the second side,
the first side is closer to an extending position of the at least one wire than is the second side, the extending position being a position at which the at least one wire separates and extends from the winding core,
a distance between the first side and the second side on the side of the inner end surface is narrower and a distance between the first side and the second side on a side of the outer end surface is wider, and
an angle of the first side with respect to the axial direction is smaller than an angle of the second side with respect to the axial direction.

2. The coil component according to claim 1, wherein
the groove is on the mounting surface of each of the first and second flanges.

3. The coil component according to claim 1, wherein
the bottom surface of the groove slopes so that the groove becomes shallower in a direction from the inner end surface to the outer end surface.

4. The coil component according to claim 1, wherein
an interior angle of each of the first and second rising surfaces with respect to the bottom surface is an obtuse angle.

5. The coil component according to claim 1, wherein
when a direction, which is an extending direction of the mounting surface and is perpendicular to the axial direction, is a widthwise direction, the groove is located toward the widthwise direction close to the extending position of the at least one wire.

6. The coil component according to claim 5, wherein
the first side extends in parallel with the axial direction.

7. The coil component according to claim 1, wherein
the distance between the first side and the second side is wider than a diameter of the at least one wire.

8. The coil component according to claim 1, wherein
a depth of the groove, which is represented by a level difference between the mounting surface and the bottom surface, is smaller than a diameter of the wire.

9. The coil component according to claim 2, wherein
the bottom surface of the groove slopes so that the groove becomes shallower in a direction from the inner end surface to the outer end surface.

10. The coil component according to claim 2, wherein
an interior angle of each of the first and second rising surfaces with respect to the bottom surface is an obtuse angle.

11. The coil component according to claim 2, wherein
when a direction, which is an extending direction of the mounting surface and is perpendicular to the axial direction, is a widthwise direction, the groove is located toward the widthwise direction close to the extending position of the at least one wire.

12. The coil component according to claim 11, wherein
the first side extends in parallel with the axial direction.

13. The coil component according to claim 2, wherein
the distance between the first side and the second side is wider than a diameter of the at least one wire.

14. The coil component according to claim 2, wherein
a depth of the groove, which is represented by a level difference between the mounting surface and the bottom surface, is smaller than a diameter of the wire.
